(19) United States
(12) Patent Application Publication
(10) Pub. No.: US 2014/0380209 A1
(43) Pub. Date: Dec. 25, 2014

(54) METHOD FOR OPERATING PORTABLE DEVICES HAVING A TOUCH SCREEN

(71) Applicant: LENOVO (SINGAPORE) PTE. LTD., SINGAPORE (SG)

(72) Inventor: YASUSHI TSUKAMOTO, Kanagawa-ken (JP)

(73) Assignee: LENOVO (SINGAPORE) PTE. LTD., SINGAPORE (SG)

(21) Appl. No.: 14/294,729

(22) Filed: Jun. 3, 2014

(30) Foreign Application Priority Data
Jun. 21, 2013 (JP) 2013-130513

(51) Int. Cl. G06F 3/0484; G06F 3/0488; G06F 3/0481

(52) U.S. Cl. CPC G06F 3/0484; G06F 3/04817; G06F 3/0488
USPC 715/763

(57) ABSTRACT

A portable device having a touch display is disclosed. A full screen having multiple graphical objects is initially presented on the touch display of the portable device. The touch display includes a comfortable operation area that is within the reach of a thumb of a hand holding the portable device, an inoperable area that is beyond the reach of the thumb of the hand holding the portable device, and a difficult operation area that is located between the comfortable operation area and the hand holding the portable device. In response to a request for a screen shifting operation, the full screen is shifted in a direction of a palm of the hand holding the portable device to present a portion of the full screen on the touch display. After receiving and confirming a user input from the touch screen, the full screen presentation is restored on the touch display.

### PRIORITY CLAIM

The present application claims benefit of priority under 35 U.S.C. §§120, 365 to the previously filed Japanese Patent Application No. JP2013-130513 with a priority date of Jun. 21, 2013, which is incorporated by reference herein.

### BACKGROUND OF THE INVENTION

1. Technical Field

The present invention relates to portable devices in general, and particularly to a method for improving one-handed operability of a portable information terminal having a touch screen.

2. Description of Related Art

A smartphone or a tablet is typically operated by touching an object, such as an icon, a character or a symbol, displayed on a touch screen with a finger. In order to detect the coordinates of a touch, a touch panel for detecting the approach or touch of the finger is used. There is also an input system using a pressure sensor for detecting a pressing force exerted on the touch screen to supplement input from the touch panel.

In recent years, there has been a growing trend to increase the size of a touch screen for a smartphone. Further, a tablet terminal with a small touch screen mounted thereon has emerged. Since a portable information terminal, such as the smartphone or the tablet terminal, is easy to carry, it is characterized in that a user can operate the portable information terminal with one hand while holding it in the hand. For the present specification, an operation method for operating a portable information terminal with one hand while holding it in the same hand is called one-handed operation.

FIG. 8 shows a state when one-handed operation of a smartphone is performed with a left thumb. The thumb capable of operating the smartphone while holding the housing stably is most suitable for one-handed operation. A screen displayed on the touch screen includes objects as targets of touch operations over the screen. Therefore, areas that cannot be operated with the thumb to perform one-handed operation exist on the touch screen. Then, the areas that cannot be operated with the thumb are expanded as the size of the touch screen becomes larger. If the holding style of the housing is changed by one hand alone to operate the smartphone with a thumb or another finger while keeping the housing in the unstable attitude, there will be a danger of falling the smartphone.

For a smartphone, after an icon has been moved to a position easy to operate with a thumb may facilitate one-handed operation. However, since the screen display is changed by moving the icon, the screen may become difficult to view or an applicable screen is limited, and this disables the above-mentioned method from being applied to the screens of popular application programs, such as a browser screen and a text input screen. Since an input screen to be displayed is shifted horizontally toward a hand to perform an operation, limited applications such as a telephone, a keypad, and a calculator pad can be operated with a thumb, though available applications are limited. Even in this case, objects that cannot be operated with the thumb remain on the touch screen.

Since the size of images is large on the smartphone, when the entire screen cannot be displayed on the touch screen, the display screen can be scrolled to display a hidden image. In this case, one-handed operation can be achieved if an object desired to input can be scrolled to come within the reach of the thumb. However, a range beyond the reach of the thumb remains on a screen with an upper limit displayed to indicate that the screen can no longer be scrolled upward. In addition, scrolling cannot be applied to a case where a screen that cannot be scrolled is displayed. Further, scrolling is done with a swipe or a flick of a finger, but this is a troublesome operation method to perform input to an object, because it is not easy for an unskilled person to do with one-handed operation.

### SUMMARY OF THE INVENTION

In accordance with a preferred embodiment of the present invention, a full screen having multiple graphical objects is initially presented on a touch display of a portable device. The touch display includes a comfortable operation area that is within the reach of a thumb of a hand holding the portable device, an inoperable area that is beyond the reach of the thumb of the hand holding the portable device, and a difficult operation area that is located between the comfortable operation area and the hand holding the portable device. In response to a request for a screen shifting operation, the full screen is shifted in a direction of a palm of the hand holding the portable device to present a portion of the full screen on the touch display. After receiving and confirming a user input from the touch screen, the full screen presentation is restored on the touch display.

All features and advantages of the present disclosure will become apparent in the following detailed written description.

### BRIEF DESCRIPTION OF THE DRAWINGS

The disclosure itself, as well as a preferred mode of use, further objects, and advantages thereof, will best be understood by reference to the following detailed description of an illustrative embodiment when read in conjunction with the accompanying drawings, wherein:

FIG. 1 shows the three different operation areas on a smartphone during a one-handed operation;

FIG. 2 is a block diagram of a smartphone;

FIG. 3 is a block diagram of the software that constitutes an input system of the smartphone from FIG. 2;

FIGS. 4A-4C are diagrams depicting a screen shifting operation;

FIG. 5 is a block diagram of the hardware configuration of the input system;

FIG. 6 is a flowchart of a method for performing a screen shifting operation;

FIG. 7 shows a screen shifting operation being performed on a window screen; and

FIG. 8 shows a state when one-handed operation is performed with a left thumb on a smartphone.

### DETAILED DESCRIPTION OF A PREFERRED EMBODIMENT

### A. One-Handed Operation and Inoperable Area

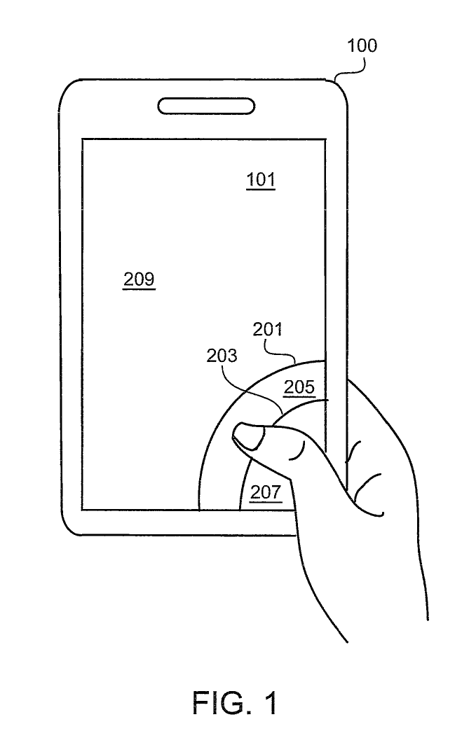

FIG. 1 shows a state in which one-handed operation of a smartphone 100 as an example of a portable information terminal is performed with a right thumb. In normal one-handed operation on a touch screen 101, it is a common practice to operate a touch panel with a thumb while holding the smartphone 100 in a right hand or left hand with a lower corner fitted in the palm. A range capable of operating the touch panel with the thumb comfortably without changing the holding position after holding it once is a roughly arc-like range with the length of the thumb set to a radius around the base of the thumb. This area on the touch screen 101 is called a comfortable operation area 205.

The comfortable operation area 205 is surrounded by an outer boundary 201 far from the hand and an inner boundary 203 close to the hand. An area closer than the inner boundary 203 can be operated by bending the thumb without switching the smartphone 100 to the other hand, but is more difficult to operate than the comfortable operation area 205. Therefore, this area is called a difficult operation area 207. An area farther than the outer boundary 201 cannot be operated by the right thumb unless the smartphone 100 is switched to the other hand. Therefore, this area is called an inoperable area 209. The comfortable operation area 205 corresponds to an area where the thumb is stretched naturally and hence easiest to perform an operation.

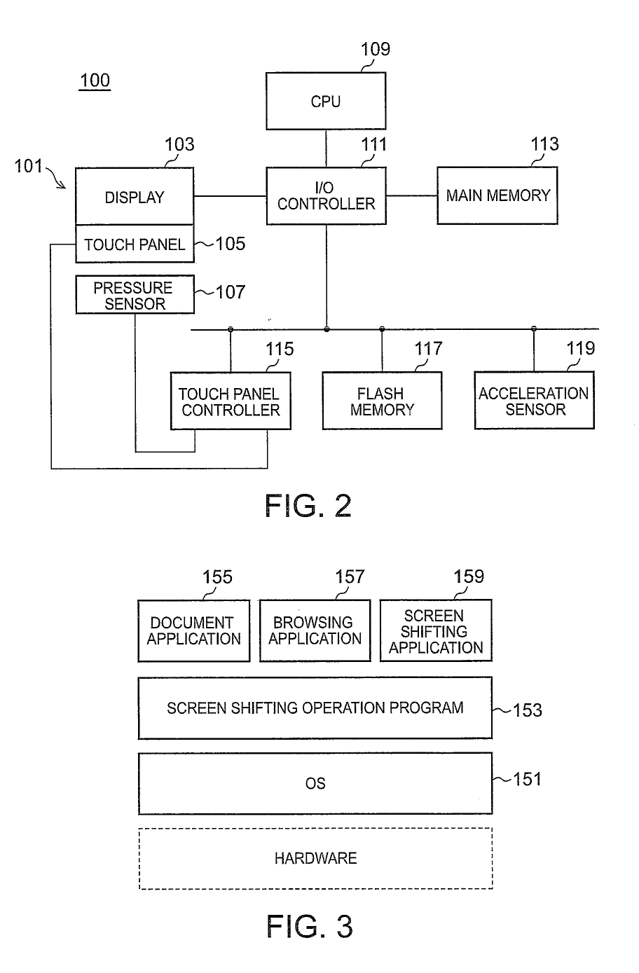

FIG. 2 is a functional block diagram of the smartphone 100. Although the smartphone 100 includes many functional devices such as a camera, audio, and radio, only functional devices necessary to describe or understand the present invention are shown in FIG. 2. Some of these functions can be integrated into one semiconductor chip or divided into individual semiconductor chips. A CPU 109, a display 103, and a main memory 113 are connected to an I/O controller 111. The I/O controller 111 provides an interface function for controlling mutual data transfer among many peripheral devices, the CPU 109, and the main memory 113, where the peripheral devices include the display 103.

As an example, a liquid crystal display (LCD) is employed as the display 103, but any other type of flat display panel such as organic EL can also be adopted. An in-cell touch panel formed with a transparent conductive film is provided in the display 103 as a touch panel 105. As another example, the touch panel 105 may be formed with transparent electrodes as a separate member and overlapped on the display 103.

As the touch panel 105, a projected capacitive type or surface capacitive type that outputs the coordinates of a position at which a finger has touched on or has approached the surface, a resistive film type that outputs the coordinates of a pressed position, or any other type can be employed. In this embodiment, the projected capacitive type is employed. A complex made up by combining the touch panel 105 and the display 103 constitutes the touch screen 101. The touch panel 105 is connected to a touch panel controller 115.

One or more pressure sensors 107 are placed in positions capable of detecting a pressing force exerted by a finger on the touch screen 101. The pressure sensor 107 may be placed below the touch screen 101, or on the back of a housing of the smartphone 100. The pressure sensor 107 is connected to the touch panel controller 115. The pressure sensor 107 cooperates with the touch panel 105 to generate an operation event for performing a screen shifting operation to be described later. The main memory 113 is a volatile memory for storing programs executed by the CPU 109.

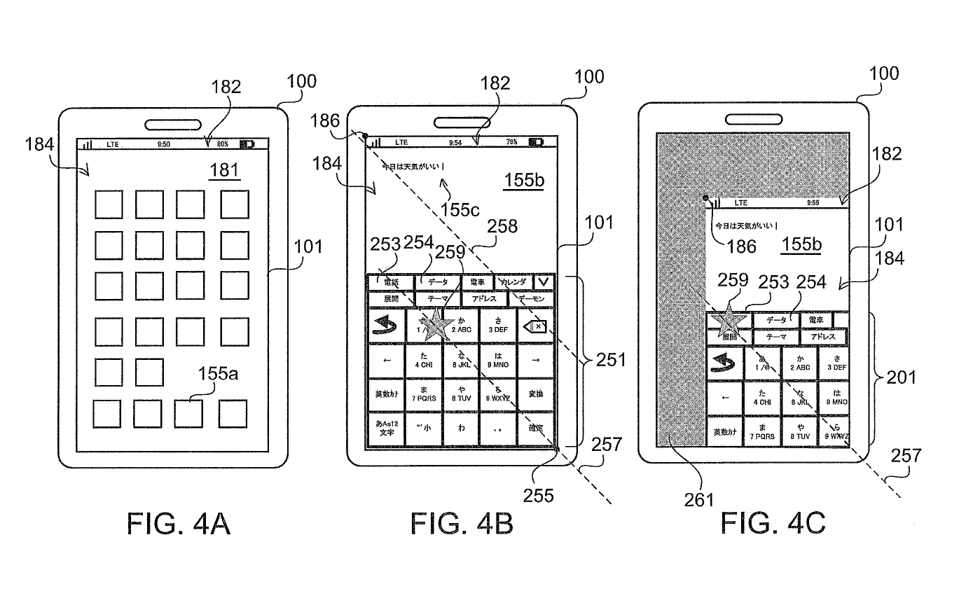

The touch panel controller 115 converts a coordinate signal received from the touch panel 105 and a pressure signal received from the pressure sensor 107 into predetermined protocol data recognizable by a program, and outputs the predetermined protocol data to the system. A flash memory 117 is a nonvolatile memory for storing an OS and applications executed by the CPU 109, and data. A program (FIGS. 4A-4C) for performing a screen shifting operation of the present invention is also stored in the flash memory 117.

An acceleration sensor 119 detects gravity acceleration generated in the housing of the smartphone 100 and the acceleration of vibration, and outputs acceleration data to the program. The acceleration sensor 119 has three detection axes (X axis, Y axis, and Z axis) that run at right angles to one another, and each detection axis detects and outputs a force component of the gravity acceleration and acceleration caused by impact applied to the housing of the smartphone 100. The OS calculates a tilt angle with respect to the gravity direction of each detection axis from the force component of the gravity acceleration received from the acceleration sensor 119, determines the longitudinal and lateral directions of the housing, and changes the display direction of a screen to be displayed on the display 103 to match the viewing direction of a user.

### B. Software Configuration

FIG. 3 is a block diagram for describing a state when programs stored in the flash memory 117 are executed by the CPU 109. A document application 155 and a browsing application 157 are shown in FIG. 3 as examples of applications. The document application 155 is executed to create a document, and the browsing application 157 is executed to access the Internet.

A screen shifting application 159 provides a user interface for registering the outer boundary 201 and the inner boundary 203 to perform a screen shifting operation to be described below. The screen shifting operation program 153 cooperates with the OS 151 to perform processing for the screen shifting operation. As an example, the screen shifting operation program 153 is placed between an application layer and a layer of the OS 151. Therefore, there is no need to alter the document application 155 and the browsing application 157 for the screen shifting operation or to add special code thereto.

### C. Outline of Screen Shifting Operation

FIGS. 4A-4C are diagrams for describing an outline when the screen shifting operation is performed on the smartphone 100 with one-handed operation using the right hand as shown in FIG. 1. The description will be made by taking the document application 155 as an example. In FIG. 4A, a home screen 181 composed of multiple icons including an icon 155a for the document application 155 is displayed on the touch screen 101. The home screen 181 is initially displayed when all applications are started, which is also called a standby screen. The home screen is called a desktop screen in the case of a laptop PC.

In addition to a client area 184 for displaying the home screen 181, a system area 182 for indicating system information, such as the radio wave state, the time, and the charging state, also appears on the touch screen 101. A user can display and operate an application screen in the client area 184, but cannot access the system area 182. A screen made up of the client area 184 and the system area 182 and displayed on the touch screen 101 is called the entire screen. The smartphone 100 is configured to display one application screen in the client area 184 on the touch screen 101. When the size (pixel count) of one screen is larger than the resolution of the display 103, there is a part hidden from the client area 184, but the hidden part can be displayed by scrolling action. The scrolling action can be achieved with a swipe or a flick on the touch screen 101.

In this example, since the icon 155a is displayed in the comfortable operation area 205, one-handed operation is enabled with a tap of the thumb. However, even when the icon 155a is displayed in the inoperable area 209, one-handed operation is enabled by a method to be described later. When a tap on the icon 155a is done, the application 155 is started, and an application screen 155b being edited is displayed in the client area 184 in a full-screen format as shown in FIG. 4B. The display position of the entire screen in FIG. 4B is called a standard position.

In the present specification, the display in the full-screen format means that one application screen is displayed over the entire client area 184, which is distinguished from a case where multiple application screens are displayed in a window format. The size of an image to be displayed in the full-screen format can be larger than the resolution of the touch screen 101. In this case, an area hidden from the screen can be displayed by scrolling action. Unlike a window screen, the display position of a screen displayed in the full-screen format cannot be changed on the home screen 181.

The application screen 155b includes a software keyboard 251. The software keyboard 251 may be part of the application 155 or be provided by the OS 151. When it is provided by the OS 151, the OS 151 that detected the start of an application requiring keyboard input displays the software keyboard 251 in a position indicated by the application in the client area 184 to be superimposed on the application screen 155b.

A cursor 155c indicative of an input position is displayed at the end of a sentence. The software keyboard 251 also includes a target object 253 corresponding to a phone key displayed in the inoperable area 209. The target object 253 denotes an icon, a character, or a symbol to which the system responds with a tap or a flick on the touch screen 101 within the home screen 181 or the application screen 151. A reference position 255 of the touch screen 101 is defined at a corner of the touch screen 101 close to the hand holding the smartphone 100.

Here, suppose that the user wants to perform input to the target object 253 with one-handed operation. The user assumes a virtual shifting straight line 257 between the reference position 255 and the target object 253 to perform a pressing operation to a pressed position 259 on the virtual shifting straight line 257 in the comfortable operation area 205. Here, touch panel operations and the pressing operation will be described. The touch panel operations are operations for causing the touch panel 105 to detect the coordinates of a touch or approach of a finger to the touch screen 101 with pressure to such an extent that does not exceed a lower limit value of the pressure sensor 107.

The touch panel operations include multiple gestures, such as a touch of a finger on the touch screen 101, a tap to release the finger soon after the touch, a swipe to move the finger while touching, and a flick to move the touching finger quickly. Tap gestures also include a long tap that is a gesture to take a long time until the finger is released. The system is also adapted to multi-touch operation, enabling input by a gesture for an operation using two or more fingers at the same time. The pressing operation is an operation for causing the pressure sensor 107 to detect pressure of a lower threshold value or larger. In the pressing operation, a gesture for detecting the coordinates of a finger that touches the touch screen 101 also takes place, but the system can detect a pressing force to distinguish the gesture from gestures for the touch panel operations.

When the pressing operation is performed, the entire screen is shifted toward the pressed position 259 along the virtual shifting straight line 257 while maintaining screen consistency without changing the screen size, the shape of a content, and the arrangement of each of the application screen 155b and the software keyboard 251. As a result, as shown in FIG. 4C, a blank screen 261 is displayed on the left edge and the upper edge of the touch screen 101, and at the same time, the application screen 155b displayed in FIG. 4B runs off the lower right edges.

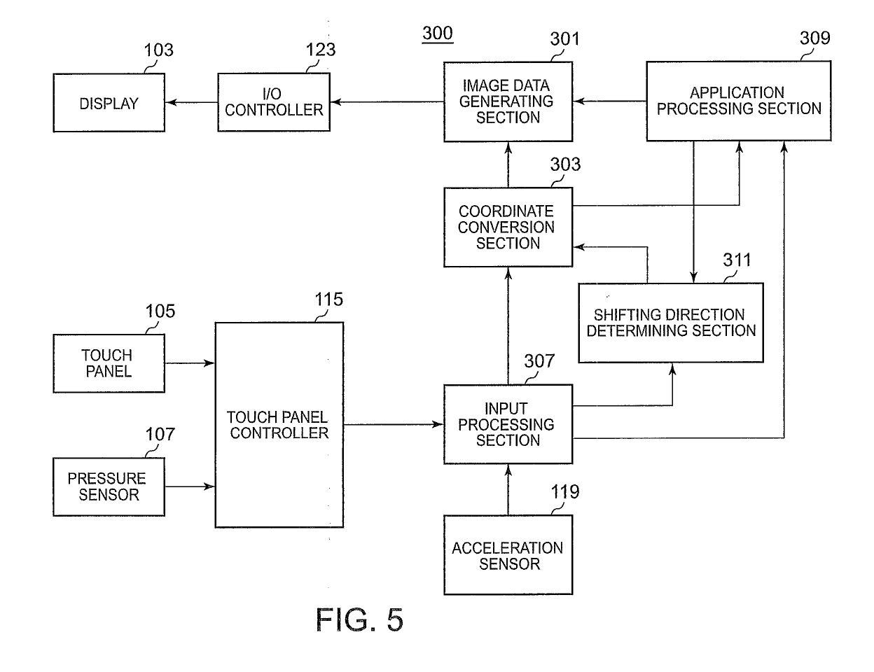

The blank screen 261 is a screen displayed in an area of the touch screen 101, where there exists no image data required by an application processing section 309, and the display 103 displays the screen in color according to the normally white or normally black characteristic. In this regard, however, an image data generating section 301 (FIG. 5) may send special image data to the area of displaying the blank screen 261 to display any background image. The entire screen continues to be shifted during the pressing operation, and the target object 253 eventually reaches the pressed position 259.

When the user who visually confirms that the target object 253 has reached the pressed position 259 releases the finger quickly to release the pressure on the pressure sensor 107, the system that detected the release recognizes that there is input to the coordinates. At this time, the system acquires the input coordinates from the touch panel 105. After the input is confirmed, the system returns the screen to the state in FIG. 4B and waits for the next input. The input operation after shifting the entire screen to make the target object 253 enter the comfortable operation area 205 this way is called a screen shifting operation.

The screen shifting operation is a manipulation technique for easily achieving one-handed operation. The screen shifting operation is achieved by cooperation between a touch panel operation and the pressing operation. At this time, the pressing operation serves to allow the system to recognize that the coordinates detected by the touch panel 101 is accompanied with the screen shifting operation. When the screen shifting operation is performed, not only does part of the application screen displayed in the standard position runs off, but also a blank screen appears. The entire screen may be defined as an application screen displayed in the client area 184. In this case, only the application screen 155b displayed in the client area 184 is shifted with the screen shifting operation without shifting the screen of the system area 182.

### D. Input System

FIG. 5 is a functional block diagram showing the configuration of an input system 300 that supports the screen shifting operation. The input system 300 is configured of the hardware resources shown in FIG. 2 and software resources shown in FIG. 3. The image data generating section 301, a coordinate conversion section 303, a shifting direction determining section 311, and an input processing section 307 can be implemented mainly by cooperation between the OS 151 and the screen shifting operation program 153, and hardware resources such as the CPU 109 executing these software resources and the main memory 113.

The application processing section 309 is implemented mainly by cooperation between software resources, such as the document application 155, the browsing application 157, the screen shifting application 159, and the OS 151, and hardware resources for executing these software resources. An application developer can create code without considering the screen shifting operation at all.

The input processing section 307 receives coordinate data and pressure data from the touch panel controller 115, and receives acceleration data from the acceleration sensor 119. When receiving no pressure data, the input processing section 307 determines a touch panel operation, and sends the application processing section 309 the coordinate data and the acceleration data received. When receiving pressure data, the input processing section 307 determines the pressing operation, sends the shifting direction determining section 311 the pressure data, the coordinate data, and the acceleration data received. When detecting input to the target object 253 performed during the screen shifting operation, the input processing section 307 sends the coordinates of the pressed position 259 to the coordinate conversion section 303.

The shifting direction determining section 311 registers data for defining the outer boundary 201 and the inner boundary 203 to identify the comfortable operation area 205, and coordinate data on the reference position 255. The shifting direction determining section 311 calculates formulas of the virtual shifting straight line 257 and a shifting straight line 258. The shifting direction determining section 311 registers whether the hand holding the smartphone 100 when a special operation is performed is the right hand or the left hand. The coordinate conversion section 303 calculates a shifting vector from the formula of the shifting straight line 258 and the pressure data, calculates the coordinates of a reference position 186 of the entire screen when being displayed on the touch screen 101, and sends the calculation results to the image data generating section 301. The coordinate conversion section 303 converts coordinate data on the pressed position 259 received from the input processing section 307 into coordinate data on the standard position, and sends it to the application processing section 309.

The application processing section 309 receives coordinate data on the input position from the input processing section 307 or the coordinate conversion section 303, and executes the document application 155 or the browsing application 157. The application processing section 309 does not recognize that the display position of the application screen 155b is changed by the coordinate conversion section 303. Based on an instruction from the application processing section 309 or the coordinate conversion section 303, the image data generating section 301 generates pixel data to be displayed on the display 103, and outputs the pixel data to an I/O controller 123.

### D. Procedure for Screen Shifting Operation

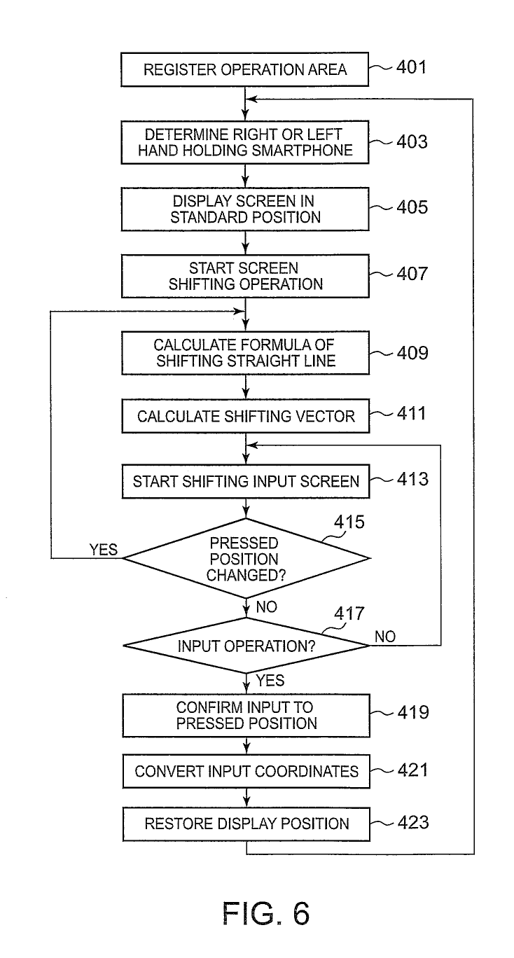

FIG. 6 is a flowchart of a method for the input system 300 to proform the screen shifting operation. In block 401, the screen shifting application 159 is started with a touch panel operation to register, with the shifting direction determining section 311, the outer boundary 201 or the outer boundary 201 and the inner boundary 203 in FIG. 1. The screen shifting application 159 displays a wizard screen on the display 103 to urge the user to tap several positions on the touch screen 101 with a thumb of the right hand and left hand in order by one-handed operation.

Coordinate data on the tap positions are sent from the application processing section 309 to the shifting direction determining section 311. As an example, the shifting direction determining section 311 creates, from the coordinates received, data indicative of the center of the annular-shaped comfortable operation area 205 approximated by a circular arc. Further, the shifting direction determining section 311 defines the outer boundary 201 or the outer boundary 201 and the inner boundary 203, which are concentric with the center of the circular arc, as circular arcs obtained by increasing/decreasing each radius at a predetermined ratio, and registers the coordinate data.

Data on the outer boundary 201 and the inner boundary 203 may be generated directly from the coordinates of the ball of the thumb that touches the screen upon swiping with the thumb. Further, the shifting direction determining section 311 registers the coordinates of the reference position 255 (FIG. 4) on the touch screen 101. As an example, the coordinates of the reference position 255 can be the coordinates of the lower right corner of the touch screen 101 in the case of one-handed operation with the right hand or the coordinates of the lower left corner in the case of one-handed operation with the left hand.

Alternatively, the coordinates of the reference position 255 can be the central coordinates of a circular arc when the outer boundary 201 and the inner boundary 203 are approximated by the circular arc. The central coordinates of the circular arc becomes a position close to the base of the thumb. The central coordinates of the circular arc may be located outside of the touch screen 101. When the registration of the coordinates of the outer boundary 201, the inner boundary 203, and the reference position 255 for each of the right hand and the left hand is completed and the screen shifting application 159 is shut down, the preparation of the screen shifting operation is completed.

In block 403, the user performs a special operation to inform the system whether the hand holding the smartphone 100 at present is the right hand or the left hand. The special operation is not particularly limited as long as it can be distinguished from a touch panel operation for an object, but it is desired that the special operation can be performed in a state of continuing the one-handed operation without switching the smartphone 100 to the other hand. As an example, the special operation can be a gesture of swiping each comfortable operation area 205 with the right thumb or left thumb while pressing the thumb.

In another example, the special operation can be an operation for characteristically shaking the smartphone once or a few times while touching each comfortable operation area with the right thumb or left thumb to cause the acceleration sensor 119 to generate an acceleration signal. The input processing section 307 sends the shifting direction determining section 311 pressure data, coordinate data, and acceleration data when the special operation is performed. From the coordinate data, the coordinate data, or the acceleration data received, the shifting direction determining section 311 recognizes and registers whether the hand holding the smartphone at present is the right hand or the left hand.

In block 405, the icon 155a is tapped on the home screen 181 in FIG. 4A to start the document application 155a. A target object displayed in the comfortable operation area 205 can be operated with a touch panel operation. When the inner boundary 203 is not defined, a target object displayed in the difficult operation area 207 can also be operated with a touch panel operation. If the icon 155a is displayed in the inoperable area 209, input to the icon 155a can also be performed by the screen shifting operation. When the tap operation is performed on the icon 155a displayed in the comfortable operation area 205, the application screen 155 is displayed on the display 103 in the full-screen format as shown in FIG. 4B.

As an example, the OS 151 defines coordinates (0, 0) at the upper left corner of the touch screen 101. The OS 151 defines the reference position 186 of the entire screen displayed on the touch screen 101. Here, the reference position 186 of the entire screen is defined at the upper left corner of the system area 182. When the application 155 requests the OS 151 to display the application screen 155b, the OS 151 displays the application screen 155b in the client area 184 in the full-screen format. The display position of the entire screen on the touch screen 101 at this time is called a standard position.

In block 407, the screen shifting operation for the target object 253 that configures the application screen 155b displayed in the inoperable area 209 is started. When access to the cursor 155c is performed to change the character input position, the cursor 155c becomes the target object. Further, when the target object 253 is hidden from a display range of the touch screen 101, the screen shifting operation can be performed after the target object 253 is scrolled and displayed in the inoperable area 209. When no inner boundary 203 is registered, the user visually assumes the virtual shifting straight line 257 that connects between the reference position 255 set at the corner of the touch screen 101 and the target object 253, and presses a position thereon with the thumb. The pressed position 259 naturally comes to the range of the comfortable operation area 205.

When the reference position 255 is defined at the center of the circular arc on the touch screen 101, the tip of the thumb only has to be directed naturally to the target object 253. When the inner boundary 203 is also defined for the operation difficult area 207, a position close to the outer boundary 201 in the comfortable operation area 205 is pressed. When the position close to the inner boundary 203 in the comfortable operation area 205 is pressed, the entire screen is so shifted that the difficult operation area 207 will approach the pressed position 259. When the screen shifting operation is performed to start shifting the entire screen by the following procedure, the input processing section 307 sends the shifting direction determining section 311 the coordinate data and the pressure data until input is confirmed.

In block 409, the shifting direction determining section 311 calculates the formula of the virtual shifting straight line 257 that connects between the coordinates of the reference position 255 on the touch screen 101 and the coordinates of the pressed position 259. Further, the shifting direction determining section 311 creates a formula of the shifting straight line 258 passing through the coordinates (0, 0) of the touch screen 101 that matches the reference position 186 of the entire screen and parallel with the virtual shifting straight line 257, and sends the formula to the coordinate conversion section 303. In block 411, the coordinate conversion section 303 calculates a shifting vector from the formula of the shifting straight line 258 and the pressure data. The shifting vector is coordinate data on the reference position 186 of the entire screen to be shifted.

In an example of calculating the shifting vector, a lower limit value and an upper limit value are set for the pressure data received from the pressure sensor 107 to calculate a position vector with the coordinates of the reference position 186 of the entire screen assigned between the lower limit value and the upper limit value. Specifically, the reference position 186 immediately before the pressure data exceeds the lower limit value is set to the coordinates (0, 0) of the touch screen 101, and the coordinates of the reference position 186 when the pressure data reaches the upper limit value is set to an intersection between the shifting straight line 258 and the coordinates of the right end of the touch screen 101. In this case, the coordinates of the reference position 186 during the screen shifting operation is either of the positions on the shifting straight line 258 in proportion to the pressing force. Thus, the target object 253 is bound to pass through the pressed position 259 until the pressure data reaches the upper limit value.

In another example of calculating the shifting vector, a velocity vector corresponding to a change in the pressing force is calculated. Specifically, the shifting velocity is made to correspond to a time differential value of the pressing force. In this case, the coordinates of the reference position 186 of the entire screen during the screen shifting operation is changed in such a manner that the application screen 155b is shifted in the lower right direction when the pressure is increased, the shifting is stopped during no change in pressing force, or the application screen 155b is shifted in a returning direction when the pressure is decreased. Then, the shifting velocity can be made proportional to the time differential value of the pressing force.

In block 413, the coordinate conversion section 303 sends the image data generating section 301 the coordinates of the reference position 186 of the entire screen continuously every predetermined time. Each time receiving the coordinates of the reference position 186, the image data generating section 313 updates the image data to make the reference position 186 math designated coordinates, and displays the entire screen in the shifted position while maintaining screen consistency. The application screen 155b is displayed in a position shifted in a lower right direction of the touch screen 101 along with the shifting of the entire screen.

As a result, the touch screen 101 displays the blank screen 261 on the left edge and the upper edge, and the target object 253 approaches the pressed position 259 while making the display of the application screen 155b run off the lower right edges. There is a case in block 415 where the user may change the pressed position 259 to correct the shifting direction because the first pressed position 259 is not appropriate. When the pressed position is changed while pressing the finger, the procedure returns to block 409. The input processing section 307 sends the shifting direction determining section 311 the coordinate data on the finger and the pressure data after the pressed position is changed. In block 409, the shifting direction determining section 311 recalculates the virtual shifting straight line 257 and the shifting straight line 258.

In block 417, the user who visually determines that the target object 253 reaches the pressed position 259 releases the finger quickly from the touch screen 101. The reason for releasing the finger quickly is because, when the finger is released slowly after starting the screen shifting operation, the position vector or the velocity vector is recalculated without confirming the input so that the entire screen can be returned to the standard position. Therefore, it is not necessary to limit the operation for confirming input to the quick release of the finger. When detecting a sudden change in pressure, the input processing section 307 determines that input is performed by the screen shifting operation, and sends the coordinates of the pressed position 259 to the coordinate conversion section 303.

In block 421, the coordinate conversion section 303 calculates the shifting amount and shifting direction of the reference position 186 of the entire screen after the start of the screen shifting operation until the input is confirmed. The coordinate conversion section 303 converts the coordinates of the pressed position 259 shown in FIG. 4C into the coordinates of the target object 253 on the application screen 155b displayed in the standard position of FIG. 4B, and sends the coordinates of the target object 253 to the application processing section 309. The application processing section 309 recognizes that the application screen 155b is always displayed in the standard position, and performs processing in response to the fact that the input operation is performed on the target object 253. After sending the coordinates of the target object 253, the coordinate conversion section 303 requests the image data generating section 301 in block 423 to display the coordinates of the reference position 186 of the entire screen to match the coordinates (0, 0) of the touch screen 101, and waits for the next input.

In the above procedure, when the inner boundary 203 is also defined in block 401, if a position in the neighborhood of the inner boundary 203 is pressed to perform input to a target object displayed in the difficult operation area 207, the shifting direction determining section 311 calculates the shifting direction to shift the application screen 155b in an upper left direction. When the input operation to one target object is confirmed, the display position of the entire screen is returned to the standard position in block 423. This method is convenient when the next target object is displayed in the comfortable operation area in the standard position.

Here, suppose that target objects 253 and 254 are displayed together in the comfortable operation area 205 with one screen shifting operation. At this time, when accessing the target object 254 following the target object 253, it is convenient if input can be performed continuously without returning the entire screen to the standard position. In this case, when the input to the target object 253 is confirmed, the coordinate conversion section 303 can stop returning the entire screen to the standard position to perform a touch panel operation continuously on the shifted application screen 155b.

As an example of the operation at this time, when receiving an event of a quick release of the finger after the entire screen is shifted to a predetermined position, the coordinate conversion section 303 fixes the display position of the entire screen to the coordinates at the time. Then, when the target objects 253 and 254 the pressing of which is stopped are tapped in order, the input processing section sends coordinate data to the application processing section 309. Further, when pressing is restarted, the shifting direction determining section 311 calculates a new virtual shifting straight line 257. Then, when the coordinate conversion section 303 shifts the entire screen again and receives an event of the quick release of the finger, the shifting of the entire screen is stopped again. Then, when receiving the event of releasing the finger slowly during the pressing operation, the coordinate conversion section 303 returns the display position of the entire screen to the standard position.

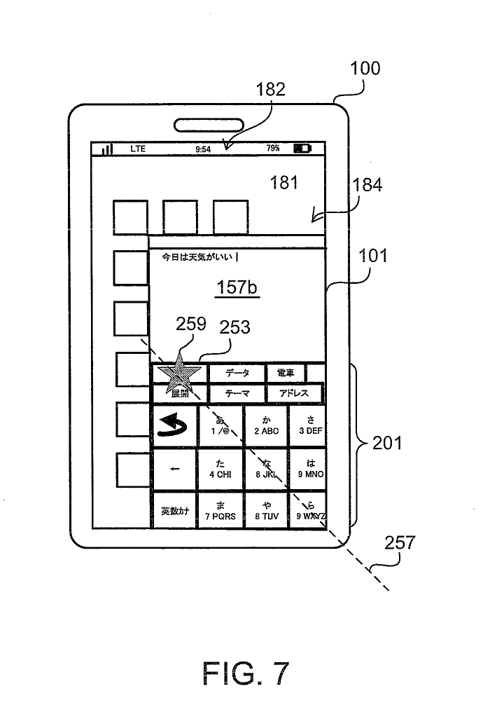

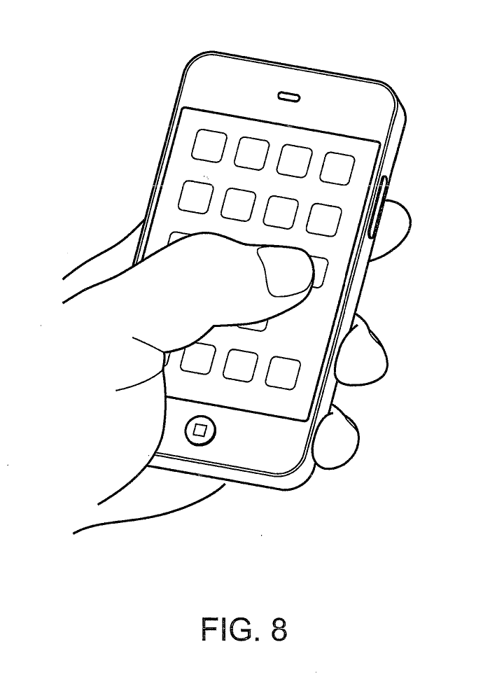

Note that the screen shifting operation can also be applied to an application screen displayed in a window format. FIG. 7 shows a state where the screen shifting operation is performed when an application screen 157b of the browsing application 157 is displayed in a window format. Among application screens displayed in the window format, an application screen displayed in the foreground becomes the target of the screen shifting operation, and the screens and the home screen 181 displayed in the background are not shifted. The application screen 157b is shifted by the screen shifting operation within a range of the client area 184, and the display runs off the edges.

On the application screen 157b, all characters, images, and icons with hyperlinks embedded therein can be set as target objects to perform input with the screen shifting operation. In this case, when input is performed to the next target object, the application screen 157b may be returned once to the position before the start of the screen shifting operation, or may be tapped after shifting is stopped to perform input to the next target object continuously.

Since the input system 300 can perform the screen shifting operation with a pressing operation and a touch panel operation on the surface of the display 103, one-handed operation can be easily performed while maintaining stable holding. Note that the present invention can be realized without using the pressure sensor. For example, when the touch screen 101 is pressed by a predetermined pressing force of a finger, the area of the touch of the finger can be calculated from the coordinates detected by the touch panel 105 to generate an event for performing the screen shifting operation.

Alternatively, a special gesture can be defined for a touch panel operation to enable the screen shifting operation after the input system 300 enters a screen shifting operation mode. For example, the shifting direction determining section 311 and the coordinate conversion section 303 are so configured that, while the input system 300 is in the screen shifting operation mode, an application screen is shifted with a swipe of a finger, and when the finger is released, the display position of the screen is fixed at the position. Although the swipe creates a blank screen and causes the application screen to run off the edges, the user can perform input with a touch panel operation after shifting the entire screen or a window screen to a convenient position.

As has been described, the present disclosure provides a method for improving one-handed operability of a portable information terminal having a touch screen.

While the disclosure has been particularly shown and described with reference to a preferred embodiment, it will be understood by those skilled in the art that various changes in form and detail may be made therein without departing from the spirit and scope of the disclosure.

What is claimed is:

1. A method comprising:
presenting on a touch display of a portable device a full screen having a plurality of graphical objects, wherein said touch display includes a comfortable operation area that is within the reach of a thumb of a hand holding said portable device, an inoperable area that is beyond the reach of said thumb of said hand holding said portable device, and a difficult operation area located between said comfortable operation area and said hand holding said portable device;
in response to a request for a screen shifting operation, shifting said full screen in a direction of a palm of said hand to present on said touch display a portion of said full screen; and
after receiving and confirming a user input from said touch display, restoring the presentation of said full screen on said touch display.

2. The method of claim 1, wherein said request is generated by an operation performed within said comfortable operation area.

3. The method of claim 1, further comprising:
defining a reference position on said touch display; and
determining a direction of shifting said full screen based on coordinates of said reference position and coordinates of a pressed position of said request.

4. The method of claim 3, wherein said direction of shifting said full screen is a direction of a straight line connecting between said coordinates of said reference position and said coordinates of said pressed position.

5. The method of claim 4, further comprising in response to a request for a change of said pressed position, determining a new direction of shifting said full screen based on coordinates of said changed pressed position and said coordinates of said reference position.

6. The method of claim 3, wherein said shifting includes determining coordinates of said full screen on said touch display according to a magnitude of a pressing force.

7. A computer readable device having a computer program product for controlling a touch display, said computer readable device comprising:
program code for presenting on a touch display of a portable device a full screen having a plurality of graphical objects, wherein said touch display includes a comfortable operation area that is within the reach of a thumb of a hand holding said portable device, an inoperable area that is beyond the reach of said thumb of said hand holding said portable device, and a difficult operation area located between said comfortable operation area and said hand holding said portable device;
program code for, in response to a request for a screen shifting operation, shifting said full screen in a direction of a palm of said hand to present on said touch display a portion of said full screen; and
program code for, after receiving and confirming a user input from said touch display, restoring the presentation of said full screen on said touch display.

8. The computer readable device of claim 7, wherein said request is generated by an operation performed within said comfortable operation area.

9. The computer readable device of claim 7, further comprising:
program code for defining a reference position on said touch display; and
program code for determining a direction of shifting said full screen based on coordinates of said reference position and coordinates of a pressed position of said request.

10. The computer readable device of claim 9, wherein said direction of shifting said full screen is a direction of a straight line connecting between said coordinates of said reference position and said coordinates of said pressed position.

11. The computer readable device of claim 10, further comprising program code for, in response to a request for a change of said pressed position, determining a new direction of shifting said full screen based on coordinates of said changed pressed position and said coordinates of said reference position.

12. The computer readable device of claim 9, wherein program code for said shifting includes program code for determining coordinates of said full screen on said touch display according to a magnitude of a pressing force.

13. A portable device comprising:
a processor;
a touch display, coupled to said processor, for displaying a full screen having a plurality of graphical objects, wherein said touch display includes a comfortable operation area that is within the reach of a thumb of a hand holding said portable device, an inoperable area that is beyond the reach of said thumb of said hand holding said portable device, and a difficult operation area located between said comfortable operation area and said hand holding said portable device; and
a touch panel controller, coupled to said touch display, for
shifting said full screen in a direction of a palm of said hand to present a portion of said full screen on said touch display, in response to a request for a screen shifting operation; and
restoring a presentation of said full screen on said touch display after receiving and confirming a user input from said touch display.
